(19) United States
(12) Patent Application Publication
(10) Pub. No.: US 2009/0247696 A1
(43) Pub. Date: Oct. 1, 2009

(54) CONJUGATED DIENE POLYMER, PROCESS FOR PRODUCING THE SAME, AND CONJUGATED DIENE POLYMER COMPOSITION AND VULCANIZATE

(75) Inventors: Toru FUJII, Chiba (JP); Mayumi Oshima, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/409,552

(22) Filed: Mar. 24, 2009

(30) Foreign Application Priority Data
Mar. 31, 2008 (JP) 2008-090695
Aug. 27, 2008 (JP) 2008-217831

(51) Int. Cl. C08L 9/00

(52) U.S. Cl. 524/572; 525/105

(57) ABSTRACT

A conjugated diene polymer is provided that includes a conjugated diene-based constituent unit and a constituent unit represented by Formula (I) below, the constituent unit represented by Formula (I) being present between a conjugated diene-based constituent unit and a conjugated diene-based constituent unit, and the content of the constituent unit represented by Formula (I) being 1 unit or 2 units per polymer chain.

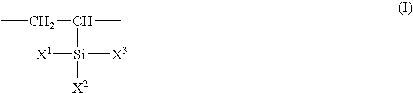

In the formula, X¹, X², and X³ independently denote a group as defined in the specification.

### TECHNICAL FIELD

The present invention relates to a conjugated diene polymer and a process for producing same, and a conjugated diene polymer composition and a vulcanizate.

### BACKGROUND OF THE INVENTION

In recent years, with the growing concern over environmental problems the demand for good fuel economy for automobiles has been becoming stronger, and there is also a demand for excellent fuel economy for polymer compositions used for automobile tires. As a polymer composition for automobile tires, a polymer composition comprising a conjugated diene polymer such as polybutadiene or a butadiene-styrene copolymer and a filler such as carbon black, etc. is used and, for example, a polymer composition employing as the conjugated diene polymer a polymer formed by modifying with a dialkylamino group-containing acrylamide a terminal of a polymer formed by copolymerizing butadiene and styrene using an alkyllithium as a polymerization initiator (see e.g. JP-A-1-217047 (JP-A denotes a Japanese unexamined patent application publication.)) is known. Furthermore, a polymer composition employing as the conjugated diene polymer a polymer formed by modifying with bis(dimethylamino)methylvinylsilane a terminal of a polymer formed by copolymerizing butadiene and styrene using an alkyllithium as a polymerization initiator (see e.g. JP-A-1-217048), a polymer composition employing as the conjugated diene polymer a polymer formed by modifying with a dialkylamino group-containing alkoxysilane a terminal of a polymer formed by polymerizing butadiene or copolymerizing butadiene and styrene, using an alkyllithium as a polymerization initiator (see e.g. JP-A-63-186748 and JP-A-2005-290355), etc. have been proposed as polymer compositions having good fuel economy.

### BRIEF SUMMARY OF THE INVENTION

However, the above-mentioned conventional polymer compositions comprising a conjugated diene polymer are not always satisfactory in terms of the balance between fuel economy and processability, particularly when silica is used as a filler.

Under such circumstances, an object of the present invention is to provide a conjugated diene polymer that can give a polymer composition having excellent fuel economy and processability when combined with silica as a filler, and a conjugated diene polymer composition formed by combining the conjugated diene polymer and a filler such as silica.

The above-mentioned object has been accomplished by means described in (1), (10), (15), and (16). (2) to (9) and (11) to (14), which are preferred embodiments, are also shown below.
(1) A conjugated diene polymer comprising a conjugated diene-based constituent unit and a constituent unit represented by Formula (I) below, the constituent unit represented by Formula (I) being present between a conjugated diene-based constituent unit and a conjugated diene-based constituent unit, and the content of the constituent unit represented by Formula (I) being 1 unit or 2 units per polymer chain,

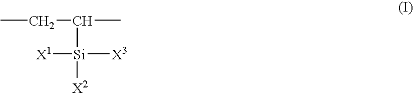

(in the formula, X¹, X², and X³ independently denote a group represented by Formula (II) below, a hydroxy group, a hydrocarbyl group, or a substituted hydrocarbyl group, and at least one of X¹, X², and X³ is a group represented by Formula (II) below or a hydroxy group)

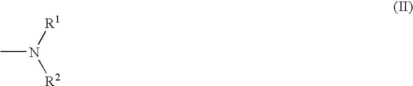

(in the formula, R¹ and R² independently denote a hydrocarbyl group having 1 to 6 carbons, a substituted hydrocarbyl group having 1 to 6 carbons, a silyl group, or a substituted silyl group, and R¹ and R² may be bonded so as to form, together with the N atom, a ring structure)
(2) the conjugated diene polymer according to (1), wherein R¹ and R² of Formula (II) are independently a methyl group, an ethyl group, an n-propyl group, or an n-butyl group,
(3) the conjugated diene polymer according to (1) or (2), wherein two of X¹, X², and X³ of Formula (I) are a group represented by Formula (II) or a hydroxy group,
(4) the conjugated diene polymer according to any one of (1) to (3), wherein, with the content of the conjugated diene-based constituent unit as 100 mol %, the conjugated diene polymer has a vinyl bond content of not less than 10 mol % but not more than 80 mol %,
(5) the conjugated diene polymer according to any one of (1) to (4), wherein it comprises, in addition to the conjugated diene-based constituent unit and the constituent unit represented by Formula (I), an aromatic vinyl-based constituent unit,
(6) the conjugated diene polymer according to (5), wherein, with the total amount of the conjugated diene-based constituent unit and the aromatic vinyl-based constituent unit as 100% by weight, the content of the aromatic vinyl-based constituent unit is not less than 10% by weight but not more than 50% by weight,
(7) the conjugated diene polymer according to any one of (1) to (6), wherein the conjugated diene polymer has a Mooney viscosity (ML₁₊₄) of not less than 10 but not more than 200,
(8) the conjugated diene polymer according to any one of (1) to (7), wherein the conjugated diene polymer has a molecular weight distribution of 1 to 2,
(9) the conjugated diene polymer according to any one of (1) to (8), wherein the constituent unit represented by Formula (I) is a bis(dialkylamino)alkylvinylsilane-based constituent unit,
(10) a conjugated diene polymer composition formed by combining the conjugated diene polymer according to any one of (1) to (9) and a filler,
(11) the conjugated diene polymer composition according to (10), wherein the amount of filler combined is not less than 10 but not more than 150 parts by weight relative to 100 parts by weight of the amount of conjugated diene polymer combined,
(12) the conjugated diene polymer composition according to (10) or (11), wherein the filler comprises silica,
(13) the conjugated diene polymer composition according to (12), wherein the amount of silica combined is not less than 50 parts by weight relative to 100 parts by weight of the total amount of filler combined,
(14) the conjugated diene polymer composition according to any one of (10) to (13), wherein it further comprises a vulcanizing agent and/or a vulcanization accelerator,
(15) a vulcanizate formed by vulcanizing the conjugated diene polymer composition according to (14), and
(16) a process for producing the conjugated diene polymer according to any one of (1) to (9), the process comprising steps A, B, and C below
(Step A) a step of polymerizing a monomer comprising a conjugated diene in a hydrocarbon solvent by an alkali metal catalyst, thus giving a conjugated diene polymer having at a polymer chain terminal an alkali metal originating from the catalyst,
(Step B) a step of adding a silicon compound represented by Formula (III) below to a hydrocarbon solution of a conjugated diene polymer having at a polymer chain terminal an alkali metal originating from an alkali metal catalyst and reacting the silicon compound with the polymer chain terminal, thus giving a conjugated diene polymer having at a polymer chain terminal a structure in which an alkali metal originating from an alkali metal catalyst is bonded to a constituent unit based on the silicon compound represented by Formula (III), and
(Step C) a step of adding a monomer comprising a conjugated diene to a hydrocarbon solution of a conjugated diene polymer having at a polymer chain terminal a structure in which an alkali metal originating from an alkali metal catalyst is bonded to a constituent unit represented by Formula (I) below, thus polymerizing the monomer at the polymer chain terminal

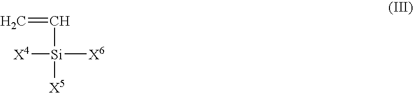

(in the formula, X⁴, X⁵, and X⁶ independently denote a group represented by Formula (II) below, a hydrocarbyl group, or a substituted hydrocarbyl group, and at least one of X⁴, X⁵, and X⁶ is a group represented by Formula (II) below)

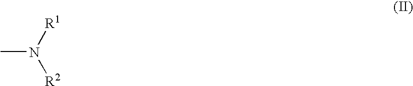

(in the formula, R¹ and R² independently denote a hydrocarbyl group having 1 to 6 carbons, a substituted hydrocarbyl group having 1 to 6 carbons, a silyl group, or a substituted silyl group, and R¹ and R² may be bonded so as to form, together with the N atom, a ring structure)

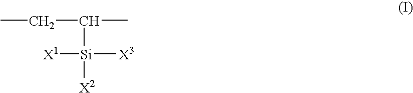

(in the formula, X¹, X², and X³ independently denote a group represented by Formula (II) below, a hydroxy group, a hydrocarbyl group, or a substituted hydrocarbyl group, and at least one of X¹, X², and X³ is a group represented by Formula (II) below or a hydroxy group)

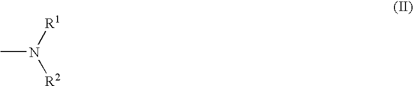

(in the formula, R¹ and R² independently denote a hydrocarbyl group having 1 to 6 carbons, a substituted hydrocarbyl group having 1 to 6 carbons, a silyl group, or a substituted silyl group, and R¹ and R² may be bonded so as to form, together with the N atom, a ring structure).

### DETAILED DESCRIPTION OF THE INVENTION

The conjugated diene polymer of the present invention is a polymer comprising a conjugated diene-based constituent unit and a constituent unit represented by Formula (I) below, the constituent unit represented by Formula (I) being present between a conjugated diene-based constituent unit and a conjugated diene-based constituent unit, and the content of the constituent unit represented by Formula (I) being 1 unit or 2 units per polymer chain.

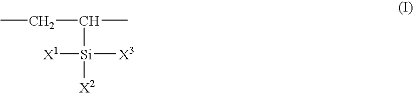

(In the formula, X¹, X², and X³ independently denote a group represented by Formula (II) below, a hydroxy group, a hydrocarbyl group, or a substituted hydrocarbyl group, and at least one of X¹, X², and X³ is a group represented by Formula (II) below or a hydroxy group.)

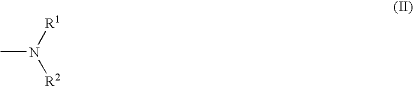

(In the formula, R¹ and R² independently denote a hydrocarbyl group having 1 to 6 carbons, a substituted hydrocarbyl group having 1 to 6 carbons, a silyl group, or a substituted silyl group, and R¹ and R² may be bonded so as to form, together with the N atom, a ring structure.)

Examples of the conjugated diene-based constituent unit include 1,3-butadiene, isoprene, 1,3-pentadiene, 2,3-dimethyl-1,3-butadiene, and 1,3-hexadiene, and one type thereof may be used or two or more types may be used. From the viewpoint of ready availability, 1,3-butadiene and isoprene are preferable.

X¹, X², and X³ of Formula (I) in the constituent unit represented by Formula (I) independently denote a group represented by Formula (II) below, a hydroxy group, a hydrocarbyl group, or a substituted hydrocarbyl group, and at least one of X¹, X², and X³ is a group represented by Formula (II) below or a hydroxy group.

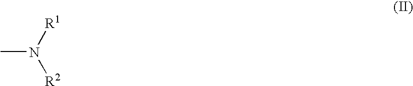

(In the formula, R¹ and R² independently denote a hydrocarbyl group having 1 to 6 carbons, a substituted hydrocarbyl group having 1 to 6 carbons, a silyl group, or a substituted silyl group, and R¹ and R² may be bonded so as to form, together with the N atom, a ring structure.)

R¹ and R² independently denote a hydrocarbyl group having 1 to 6 carbons, a substituted hydrocarbyl group having 1 to 6 carbons, a silyl group, or a substituted silyl group, and R¹ and R² may be bonded so as to form, together with the N atom, a ring structure.

In the present specification, the hydrocarbyl group denotes a hydrocarbon residue. The substituted hydrocarbyl group denotes a group in which at least one hydrogen atom of the hydrocarbon residue is replaced by a substituent. The substituted silyl group denotes a group in which at least one hydrogen atom of a silyl group is replaced by a substituent.

Examples of R¹ and R² include alkyl groups such as a methyl group, an ethyl group, an n-propyl group, an isopropyl group, an n-butyl group, a sec-butyl group, a tert-butyl group, an n-pentyl group, a neopentyl group, an isopentyl group, and an n-hexyl group; a cyclohexyl group; a phenyl group; alkoxyalkyl groups such as a methoxymethyl group; a methoxyethyl group, an ethoxymethyl group, and an ethoxyethyl group; and trialkylsilyl groups such as a trimethylsilyl group and a t-butyldimethylsilyl group.

Examples of groups in which R¹ and R² are bonded include alkylene groups such as a trimethylene group, a tetramethylene group, a pentamethylene group, and a hexamethylene group; oxydialkylene groups such as an oxydiethylene group and an oxydipropylene group; and nitrogen-containing groups such as a group represented by —CH₂CH₂—NH—CH₂— and a group represented by —CH₂CH₂—N═CH—.

The hydrocarbyl group denoted by R¹ and R² is preferably an alkyl group, the substituted hydrocarbyl group denoted by R¹ and R² is preferably an alkoxyalkyl group, and the substituted silyl group is preferably a trialkylsilyl group.

R¹ and R² are preferably a substituted hydrocarbyl group having 1 to 6 carbons in which a substituent is a group selected from a group consisting of a nitrogen atom-containing group, an oxygen atom-containing group, and a silicon atom-containing group, a hydrocarbyl group having 1 to 6 carbons, or a substituted silyl group, are more preferably a substituted hydrocarbyl group having 1 to 4 carbons in which a substituent is a group selected from the group consisting of a nitrogen atom-containing group, an oxygen atom-containing group, and a silicon atom-containing group, a hydrocarbyl group having 1 to 4 carbons, or a substituted silyl group, are yet more preferably a methyl group, an ethyl group, an n-propyl group, an n-butyl group, a trimethylsilyl group, a group represented by —CH₂CH₂—NH—CH₂—, or a group represented by —CH₂CH₂—N═CH—, are particularly preferably a methyl group, an ethyl group, an n-propyl group, or an n-butyl group, and are most preferably an ethyl group or an n-butyl group.

Examples of the group represented by Formula (II) include an acyclic amino group and a cyclic amino group. As the acyclic amino group there can be cited a dialkylamino group, a di(alkoxyalkyl)amino group, a di(trialkylsilyl)amino group, etc. Examples thereof include a dimethylamino group, a diethylamino group, a di(n-propyl)amino group, a di(isopropyl)amino group, a di(n-butyl)amino group, a di(sec-butyl)amino group, a di(tert-butyl)amino group, a di(neopentyl)amino group, an ethylmethylamino group, a di(methoxymethyl)amino group, a di(methoxyethyl)amino group, a di(ethoxymethyl)amino group, a di(ethoxyethyl)amino group, a di(trimethylsilyl)amino group, and a di(t-butyldimethylsilyl)amino group.

Examples of the cyclic amino group include a 1-pyrrolidinyl group, a piperidino group, and 1-polymethyleneimino groups such as a 1-hexamethyleneimino group, a 1-heptamethyleneimino group, a 1-octamethyleneimino group, a 1-decamethyleneimino group, a 1-dodecamethyleneimino group, a 1-tetradecamethyleneimino group, and a 1-octadecamethyleneimino group. Further examples of the cyclic amino group include a 1-imidazolyl group, a 4,5-dihydro-1-imidazolyl group, a 1-imidazolidinyl group, a 1-piperazinyl group, and a morpholino group.

From the viewpoint of economy and ready availability, the group represented by Formula (II) is preferably an acyclic amino group, more preferably a dialkylamino group, and further preferably a dimethylamino group, a diethylamino group, a di(n-propyl)amino group, or a di(n-butyl)amino group. Among them, from the viewpoint of ready availability of the compound, a diethylamino group and a di(n-butyl)amino group are preferable.

Examples of the hydrocarbyl group denoted by X¹ to X³ of Formula (I) include alkyl groups such as a methyl group, an ethyl group, an n-propyl group, an isopropyl group, an n-butyl group, a sec-butyl group, and a tert-butyl group. Furthermore, examples of the substituted hydrocarbyl group include alkoxyalkyl groups such as a methoxymethyl group, an ethoxymethyl group, a methoxyethyl group, and an ethoxyethyl group. The hydrocarbyl group is preferably an alkyl group, and the substituted hydrocarbyl group is preferably an alkoxyalkyl group.

The hydrocarbyl group and substituted hydrocarbyl group denoted by X¹ to X³ are preferably a hydrocarbyl group having 1 to 4 carbons or a substituted hydrocarbyl group having 1 to 4 carbons, and are more preferably a methyl group or an ethyl group.

At least one of X¹, X², and X³ of Formula (I) is a group represented by Formula (II) or a hydroxy group. It is preferable that at least two of X¹, X², and X³ are a group represented by Formula (II) or a hydroxy group, and it is more preferable that two of X¹, X², and X³ are a group represented by Formula (II) or a hydroxy group.

Examples of the constituent unit represented by Formula (I) include a silicon compound-based constituent unit represented by Formula (III), which is described later. From the viewpoint of fuel economy and processability, it is preferably a bis(dialkylamino)alkylvinylsilane-based constituent unit, more preferably a bis(dialkylamino)methylvinylsilane-based constituent unit, and yet more preferably a bis(dimethylamino)methylvinylsilane-based constituent unit, a bis(diethylamino)methylvinylsilane-based constituent unit, a bis(di-n-propylamino)methylvinylsilane-based constituent unit, or a bis(di-n-butylamino)methylvinylsilane-based constituent unit. Among them, from the viewpoint of ready availability of the compound, a bis(diethylamino)methylvinylsilane-based constituent unit and a bis(di-n-butylamino)methylvinylsilane-based constituent unit are preferable.

The conjugated diene polymer of the present invention has a constituent unit represented by Formula (I) between a conjugated diene-based constituent unit and a conjugated diene-based constituent unit, and from the viewpoint of processability the content of the constituent unit represented by Formula (I) in the conjugated diene polymer is 1 unit or 2 units per polymer chain.

The conjugated diene polymer of the present invention may comprise, in addition to the conjugated diene-based constituent unit (conjugated diene unit) and the constituent unit represented by Formula (I), a constituent unit based on another monomer. Examples of said other monomer include an aromatic vinyl, a vinylnitrile, and an unsaturated carboxylic acid ester. Examples of the aromatic vinyl include styrene, α-methylstyrene, vinyltoluene, vinylnaphthalene, divinylbenzene, trivinylbenzene, and divinyinaphthalene. Examples of the vinylnitrile include acrylonitrile, and examples of the unsaturated carboxylic acid ester include methyl acrylate, ethyl acrylate, methyl methacrylate, and ethyl methacrylate. Among them, an aromatic vinyl is preferable, and styrene is more preferable.

The conjugated diene polymer of the present invention preferably comprises an aromatic vinyl-based constituent unit (aromatic vinyl unit) from the viewpoint of strength, and the content of the aromatic vinyl unit, relative to 100% by weight of the total amount of the conjugated diene unit and the aromatic vinyl unit, is preferably not less than 10% by weight (the content of the conjugated diene unit being not more than 90% by weight), and more preferably not less than 15% by weight (the content of the conjugated diene unit being not more than 85% by weight). Furthermore, from the viewpoint of fuel economy, the content of the aromatic vinyl unit is preferably not more than 50% by weight (the content of the conjugated diene unit being not less than 50% by weight), and more preferably not more than 45% by weight (the content of the conjugated diene unit being not less than 55% by weight).

From the viewpoint of strength, the Mooney viscosity (ML₁₊₄) of the conjugated diene polymer of the present invention is preferably not less than 10, and more preferably not less than 20. Furthermore, from the viewpoint of processability, it is preferably not more than 200, and more preferably not more than 150. The Mooney viscosity (ML₁₊₄) is measured at 100° C. in accordance with JIS K6300 (1994).

From the viewpoint of fuel economy, the vinyl bond content of the conjugated diene polymer of the present invention, with the content of the conjugated diene unit as 100 mol %, is preferably not more than 80 mol %, and more preferably not more than 70 mol %. Furthermore, from the viewpoint of grip properties, it is preferably not less than 10 mol %, more preferably not less than 15 mol %, yet more preferably not less than 20 mol %, and particularly preferably not less than 40 mol %. The vinyl bond content may be obtained by IR spectroscopy from the absorption intensity at around 910 cm⁻¹, which is an absorption peak of a vinyl group.

The vinyl bond content referred to here means the ethylenically unsaturated bond content.

From the viewpoint of the balance between fuel economy and processability, the molecular weight distribution of the conjugated diene polymer of the present invention is preferably not less than 1 but not more than 5, and more preferably not less than 1 but not more than 2. The molecular weight distribution is obtained by measuring number-average molecular weight (Mn) and weight-average molecular weight (Mw) by a gel permeation chromatograph (GPC) method, and dividing Mw by Mn.

As a process for producing the conjugated diene polymer of the present invention, a production process comprising (step A), (step B), and (step C) below can be cited.
(Step A): a step of polymerizing a monomer comprising a conjugated diene in a hydrocarbon solvent by an alkali metal catalyst, thus giving a conjugated diene polymer having at a polymer chain terminal an alkali metal originating from the catalyst,
(Step B): a step of adding a silicon compound represented by Formula (III) below to a hydrocarbon solution of a conjugated diene polymer having at a polymer chain terminal an alkali metal originating from an alkali metal catalyst and reacting the silicon compound with the polymer chain terminal, thus giving a conjugated diene polymer having at a polymer chain terminal a structure in which an alkali metal originating from an alkali metal catalyst is bonded to a constituent unit based on the silicon compound represented by Formula (III),

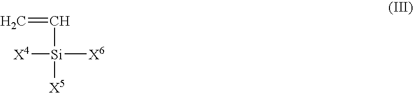

(in the formula, X⁴, X⁵, and X⁶ independently denote a group represented by Formula (II) below, a hydrocarbyl group, or a substituted hydrocarbyl group, and at least one of X⁴, X⁵, and X⁶ is a group represented by Formula (II) below)

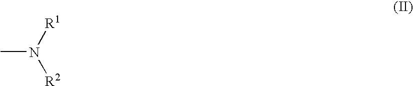

(in the formula, R¹ and R² independently denote a hydrocarbyl group having 1 to 6 carbons, a substituted hydrocarbyl group having 1 to 6 carbons, a silyl group, or a substituted silyl group, and R¹ and R² may be bonded so as to form, together with the N atom, a ring structure)
(Step C): a step of adding a monomer comprising a conjugated diene to the hydrocarbon solution of a conjugated diene polymer having at a polymer chain terminal a structure in which an alkali metal originating from an alkali metal catalyst is bonded to a constituent unit based on Formula (I), thus polymerizing the monomer at the polymer chain terminal.

Examples of the alkali metal catalyst used in (step A) include an alkali metal, an organoalkali metal compound, a complex between an alkali metal and a polar compound, and an oligomer having an alkali metal. Examples of the alkali metal include lithium, sodium, potassium, rubidium, and cesium. Examples of the organoalkali metal compound include ethyllithium, n-propyllithium, iso-propyllithium, n-butyllithium, sec-butyllithium, t-octyllithium, n-decyllithium, phenyllithium, 2-naphthyllithium, 2-butylphenyllithium, 4-phenylbutyllithium, cyclohexyllithium, 4-cyclopentyllithium, dimethylaminopropyllithium, diethylaminopropyllithium, t-butyldimethylsilyloxypropyllithium, N-morpholinopropyllithium, lithium hexamethyleneimide, lithium pyrrolidide, lithium piperidide, lithium heptamethyleneimide, lithium dodecamethyleneimide, 1,4-dilithiobutene-2, sodium naphthalene, sodium biphenyl, and potassium naphthalene. Examples of the complex between an alkali metal and a polar compound include a potassium-tetrahydrofuran complex and a potassium-diethoxyethane complex, and examples of the oligomer having an alkali metal include the sodium salt of α-methylstyrene tetramer. Among them, an organolithium compound or an organosodium compound is preferable, and an organolithium compound or organosodium compound having 2 to 20 carbons is more preferable.

The hydrocarbon solvent used in (step A) is a solvent that does not deactivate the alkali metal catalyst, and examples thereof include an aliphatic hydrocarbon, an aromatic hydrocarbon, and an alicyclic hydrocarbon. Specific examples of the aliphatic hydrocarbon include propane, n-butane, iso-butane, n-pentane, iso-pentane, n-hexane, propene, 1-butene, iso-butene, trans-2-butene, cis-2-butene, 1-pentene, 2-pentene, 1-hexene, and 2-hexene. Specific examples of the aromatic hydrocarbon include benzene, toluene, xylene, and ethylbenzene, and specific examples of the alicyclic hydrocarbon include cyclopentane and cyclohexane. They may be used on their own or in a combination of two or more types. Among them, a hydrocarbon having 2 to 12 carbons is preferable.

In (step A), a monomer comprising a conjugated diene is polymerized to thus produce a conjugated diene polymer having at a polymer terminal an alkali metal originating from the above-mentioned alkali metal catalyst. Examples of the conjugated diene include 1,3-butadiene, isoprene, 1,3-pentadiene, 2,3-dimethyl-1,3-butadiene, and 1,3-hexadiene, and they may be used on their own or in a combination of two or more types. Among them, from the viewpoint of ready availability, 1,3-butadiene and isoprene are preferable.

In (step A), polymerization may be carried out using the conjugated diene on its own or polymerization may be carried out using a combination of the conjugated diene and another monomer. Examples of said other monomer include an aromatic vinyl, a vinylnitrile, and an unsaturated carboxylic acid ester. Specific examples of the aromatic vinyl include styrene, α-methylstyrene, vinyltoluene, vinylnaphthalene, divinylbenzene, trivinylbenzene, and divinyinaphthalene. Specific examples of the vinylnitrile include acrylonitrile, and specific examples of the unsaturated carboxylic acid ester include methyl acrylate, ethyl acrylate, methyl methacrylate, and ethyl methacrylate. Among them, from the viewpoint of ready availability, an aromatic vinyl is preferable, and styrene is more preferable.

The polymerization in (step A) may be carried out in the presence of an agent for regulating the vinyl bond content of the conjugated diene unit, an agent for regulating the distribution in the conjugated diene polymer chain of the conjugated diene unit and a constituent unit based on a monomer other than the conjugated diene (hereafter, generally called ‘regulators’), etc. Examples of such agents include an ether compound, a tertiary amine, and a phosphine compound. Specific examples of the ether compound include cyclic ethers such as tetrahydrofuran, tetrahydropyran, and 1,4-dioxane; aliphatic monoethers such as diethyl ether and dibutyl ether; aliphatic diethers such as ethylene glycol dimethyl ether, ethylene glycol diethyl ether, ethylene glycol dibutyl ether, diethylene glycol diethyl ether, and diethylene glycol dibutyl ether; and aromatic ethers such as diphenyl ether and anisole. Specific examples of the tertiary amine include triethylamine, tripropylamine, tributylamine, N,N,N′,N′-tetramethylethylenediamine, N,N-diethylaniline, pyridine, and quinoline. Specific examples of the phosphine compound include trimethylphosphine, triethylphosphine, and triphenylphosphine. They may be used on their own or in a combination of two or more types.

The polymerization temperature in (step A) is usually not less than 25° C. but not more than 100° C., preferably not less than 35° C. but not more than 90° C., and yet more preferably not less than 50° C. but not more than 80° C. The polymerization time is usually not less than 10 minutes but not more than 5 hours.

With regard to the silicon compound represented by Formula (III) used in (step B), X⁴, X⁵, and X⁶ of Formula (III) independently denote a group represented by Formula (II), a hydrocarbyl group, or a substituted hydrocarbyl group, and at least one of X⁴, X⁵, and X⁶ is a group represented by Formula (II).

In the silicon compound represented by Formula (III), examples of R¹ and R² of Formula (II), preferred groups, examples of Formula (II), and preferred groups are the same as examples of R¹ and R² of Formula (II), preferred groups, examples of Formula (II), and preferred groups described above for Formula (I).

Examples of the hydrocarbyl group denoted by X⁴ to X⁶ of Formula (III) include alkyl groups such as a methyl group, an ethyl group, an n-propyl group, an isopropyl group, an n-butyl group, a sec-butyl group, and a tert-butyl group. Furthermore, examples of the substituted hydrocarbyl group include alkoxyalkyl groups such as a methoxymethyl group, an ethoxymethyl group, a methoxyethyl group, and an ethoxyethyl group. The hydrocarbyl group is preferably an alkyl group, and the substituted hydrocarbyl group is preferably an alkoxyalkyl group.

The hydrocarbyl group and substituted hydrocarbyl group denoted by X⁴ to X⁶ are preferably a hydrocarbyl group having 1 to 4 carbons or a substituted hydrocarbyl group having 1 to 4 carbons, and are more preferably a methyl group or an ethyl group.

With regard to the silicon compound represented by Formula (III), as a compound in which one of X⁴ to X⁶ is an acyclic amino group represented by Formula (II) and two thereof are a hydrocarbyl group or a substituted hydrocarbyl group there can be cited a (dialkylamino)dialkylvinylsilane, a {di(trialkylsilyl)amino}dialkylvinylsilane, and a (dialkylamino)dialkoxyalkylvinylsilane.

Examples thereof include (dimethylamino)dimethylvinylsilane, (ethylmethylamino)dimethylvinylsilane, (diethylamino)dimethylvinylsilane, (ethyl-n-propylamino)dimethylvinylsilane, (ethylisopropylamino)dimethylvinylsilane, (di-n-propylamino)dimethylvinylsilane, (diisopropylamino)dimethylvinylsilane, (n-butyl-n-propylamino)dimethylvinylsilane, (di-n-butylamino)dimethylvinylsilane, (dimethylamino)diethylvinylsilane, (ethylmethylamino)diethylvinylsilane, (diethylamino)diethylvinyisilane, (ethyl-n-propylamino)diethylvinylsilane, (ethylisopropylamino)diethylvinylsilane, (di-n-propylamino)diethylvinylsilane, (diisopropylamino)diethylvinylsilane, (n-butyl-n-propylamino)diethylvinylsilane, (di-n-butylamino)diethylvinyisilane, (dimethylamino)dipropylvinylsilane, (ethylmethylamino)dipropylvinylsilane, (diethylamino)dipropylvinylsilane, (ethyl-n-propylamino)dipropylvinylsilane, (ethylisopropylamino)dipropylvinylsilane, (di-n-propylamino)dipropylvinylsilane, (diisopropylamino)dipropylvinylsilane, (n-butyl-n-propylamino)dipropylvinylsilane, (di-n-butylamino)dipropylvinylsilane, (dimethylamino)dibutylvinylsilane, (ethylmethylamino)dibutylvinylsilane, (diethylamino)dibutylvinylsilane, (ethyl-n-propylamino)dibutylvinylsilane, (ethylisopropylamino)dibutylvinylsilane, (di-n-propylamino)dibutylvinylsilane, (diisopropylamino)dibutylvinylsilane, (n-butyl-n-propylamino)dibutylvinylsilane, (di-n-butylamino)dibutylvinylsilane, {di(trimethylsilyl)amino}dimethylvinylsilane, {di(t-butyldimethylsilyl)amino}dimethylvinylsilane, {di(trimethylsilyl)amino}diethylvinylsilane, {di(t-butyidimethylsilyl)amino}diethylvinylsilane, (dimethylamino)dimethoxymethylvinylsilane, (dimethylamino)dimethoxyethylvinylsilane, (dimethylamino)diethoxymethylvinylsilane, (dimethylamino)diethoxyethylvinylsilane, (diethylamino)dimethoxymethylvinylsilane, (diethylamino)dimethoxyethylvinylsilane, (diethylamino)diethoxymethylvinylsilane, and (diethylamino)diethoxyethylvinylsilane.

As a compound in which two of X⁴ to X⁶ are acyclic amino groups represented by Formula (II) and one thereof is a hydrocarbyl group or a substituted hydrocarbyl group there can be cited a bis(dialkylamino)alkylvinylsilane, a bis{di(trialkylsilyl)amino}alkylvinylsilane, and a bis(dialkylamino)alkoxyalkylvinylsilane.

Examples thereof include bis(dimethylamino)methylvinylsilane, bis(ethylmethylamino)methylvinylsilane, bis(diethylamino)methylvinylsilane, bis(ethyl-n-propylamino)methylvinylsilane, bis(ethylisopropylamino)methylvinylsilane, bis(di-n-propylamino)methylvinylsilane, bis(diisopropylamino)methylvinylsilane, bis(n-butyl-n-propylamino)methylvinylsilane, bis(di-n-butylamino)methylvinylsilane, bis(dimethylamino)ethylvinylsilane, bis(ethylmethylamino)ethylvinylsilane, bis(diethylamino)ethylvinylsilane, bis(ethyl-n-propylamino)ethylvinylsilane, bis(ethylisopropylamino)ethylvinylsilane, bis(di-n-propylamino)ethylvinylsilane, bis(diisopropylamino)ethylvinylsilane, bis(n-butyl-n-propylamino)ethylvinylsilane, bis(di-n-butylamino)ethylvinylsilane, bis(dimethylamino)propylvinylsilane, bis(ethylmethylamino)propylvinylsilane, bis(diethylamino)propylvinylsilane, bis(ethyl-n-propylamino)propylvinylsilane, bis(ethylisopropylamino)propylvinylsilane, bis(di-n-propylamino)propylvinylsilane, bis(diisopropylamino)propylvinylsilane, bis(n-butyl-n-propylamino)propylvinylsilane, bis(di-n-butylamino)propylvinylsilane, bis(dimethylamino)butylvinylsilane, bis(ethylmethylamino)butylvinylsilane, bis(diethylamino)butylvinylsilane, bis(ethyl-n-propylamino)butylvinylsilane, bis(ethylisopropylamino)butylvinylsilane, bis(di-n-propylamino)butylvinylsilane, bis(diisopropylamino)butylvinylsilane, bis(n-butyl-n-propylamino)butylvinylsilane, bis(di-n-butylamino)butylvinylsilane, bis{di(trimethylsilyl)amino}methylvinylsilane, bis{di(t-butyidimethylsilyl)amino}methylvinylsilane, bis{di(trimethylsilyl)amino}ethylvinylsilane, bis{di(t-butyldimethylsilyl)amino}ethylvinylsilane, bis(dimethylamino)methoxymethylvinylsilane, bis(dimethylamino)methoxyethylvinylsilane, bis(dimethylamino)ethoxymethylvinylsilane, bis(dimethylamino)ethoxyethylvinylsilane, bis(diethylamino)methoxymethylvinylsilane, bis(diethylamino)methoxyethylvinylsilane, bis(diethylamino)ethoxymethylvinylsilane, and bis(diethylamino)ethoxyethylvinylsilane.

As a compound in which three of X⁴ to X⁶ are acyclic amino groups represented by Formula (II) there can be cited a tri(dialkylamino)vinylsilane, etc.

Examples thereof include tri(dimethylamino)vinylsilane, tri(ethylmethylamino)vinylsilane, tri(diethylamino)vinylsilane, tri(ethylpropylamino)vinylsilane, tri(dipropylamino)vinylsilane, and tri(butylpropylamino)vinylsilane.

With regard to the silicon compound represented by Formula (III), examples of a compound in which at least one of X⁴ to X⁶ is a cyclic amino group represented by Formula (II) include bis(morpholino)methylvinylsilane, bis(piperidino)methylvinylsilane, bis(4,5-dihydroimidazolyl)methylvinylsilane, and bis(hexamethyleneimino)methylvinylsilane.

At least one of X⁴, X⁵, and X⁶ of Formula (III) is a group represented by Formula (II). It is preferable that at least two of X⁴, X⁵, and X⁶ are a group represented by Formula (II), and it is more preferable that two of X⁴, X⁵, and X⁶ are a group represented by Formula (II).

The silicon compound represented by Formula (III) in which two of X⁴, X⁵, and X⁶ are a group represented by Formula (II) is preferably a silicon compound in which two of X⁴, X⁵, and X⁶ are an acyclic amino group; from the viewpoint of fuel economy and processability it is more preferably a bis(dialkylamino)alkylvinylsilane, and yet more preferably bis(dimethylamino)methylvinylsilane, bis(diethylamino)methylvinylsilane, bis(di-n-propylamino)methylvinylsilane, or bis(di-n-butylamino)methylvinylsilane. Among them, from the viewpoint of ready availability of the compound, bis(diethylamino)methylvinylsilane or bis(di-n-butylamino)methylvinylsilane is preferable.

In (step B), the addition of the silicon compound represented by Formula (III) is usually carried out quickly in a state in which the hydrocarbon solution is stirred.

From the viewpoint of fuel economy, the amount of silicon compound represented by Formula (III) added is preferably not less than 0.5 mol per mol of alkali metal originating from an alkali metal catalyst, and more preferably not less than 0.7 mol. Furthermore, from the viewpoint of economy during production, it is preferably not more than 1.5 mol per step of (step B), and more preferably not more than 1.2 mol.

The silicon compound represented by Formula (III) may be dissolved in a solvent such as tetrahydrofuran or hexane that does not deactivate the alkali metal catalyst, and added as a solution to the hydrocarbon solution.

From the viewpoint of smooth progress of the reaction of the silicon compound represented by Formula (III), the conjugated diene polymer concentration in hydrocarbon solution before adding the silicon compound is preferably not more than 30% by weight, and more preferably not more than 20% by weight. Furthermore, from the viewpoint of productivity, it is preferably not less than 5% by weight, and more preferably not less than 10% by weight.

With regard to the stirring speed for the hydrocarbon solution when adding the silicon compound represented by Formula (III), from the viewpoint of enhancing fuel economy and smooth progress of the reaction of the silicon compound, it is preferably not less than 30 rpm, more preferably not less than 50 rpm, and yet more preferably not less than 70 rpm. Furthermore, from the viewpoint of economy, it is preferably not more than 400 rpm, and more preferably 200 rpm or less. The temperature of the hydrocarbon solution when the silicon compound is added is usually not less than 35° C. but not more than 100° C.

It is preferable to stir the hydrocarbon solution after the silicon compound represented by Formula (III) is added. The stirring speed is usually not less than 100 rpm, the temperature is usually not less than 35° C., and the time is usually not more than 1 sec but not more than 30 minutes.

In (step C), a monomer comprising a conjugated diene is added to the hydrocarbon solution of the conjugated diene polymer having at the polymer chain terminal the structure in which an alkali metal originating from an alkali metal catalyst is bonded to the Formula (I)-based constituent unit produced in (step B), thus polymerizing the monomer at the polymer chain terminal. Examples of the conjugated diene include 1,3-butadiene, isoprene, 1,3-pentadiene, 2,3-dimethyl-1,3-butadiene, and 1,3-hexadiene, and they may be used on their own or in a combination of two or more types. Among them, from the viewpoint of ready availability, 1,3-butadiene and isoprene are preferable.

In (step C), polymerization may be carried out using the conjugated diene on its own or polymerization may be carried out using a combination of the conjugated diene and another monomer. Examples of said other monomer include an aromatic vinyl, a vinylnitrile, and an unsaturated carboxylic acid ester. Specific examples of the aromatic vinyl include styrene, α-methylstyrene, vinyltoluene, vinylnaphthalene, divinylbenzene, trivinylbenzene, and divinylnaphthalene. Specific examples of the vinyinitrile include acrylonitrile, and specific examples of the unsaturated carboxylic acid ester include methyl acrylate, ethyl acrylate, methyl methacrylate, and ethyl methacrylate. Among them, an aromatic vinyl is preferable, and styrene is more preferable.

The polymerization temperature in (step C) is usually not less than 35° C. but not more than 100° C., and preferably not less than 50° C. but not more than 80° C. The polymerization time is usually not less than 10 minutes but not more than 5 hours.

When producing a conjugated diene polymer, (step B) and (step C) may be provided a plurality of times as long as the content of the constituent unit represented by Formula (I) is 1 unit or 2 units per polymer chain.

In the production process of the present invention, a coupling agent may be added to the hydrocarbon solution of the conjugated diene polymer as necessary from initiation of polymerization of monomer by an alkali metal catalyst to termination of polymerization. Examples of the coupling agent include a compound represented by Formula (IV) below.

R³ₐML₄₋ₐ (IV)

(In the formula, R³ denotes an alkyl group, an alkenyl group, a cycloalkenyl group, or an aromatic residue, M denotes a silicon atom or a tin atom, L denotes a halogen atom or a hydrocarbyloxy group, and a denotes an integer of 0 to 2.)

Here, the aromatic residue denotes a monovalent group in which a hydrogen bonded to an aromatic ring is removed from an aromatic hydrocarbon, and the hydrocarbyloxy group denotes a monovalent group in which a hydrocarbyl group is bonded to oxy (—O—).

R³ is preferably an alkyl group, alkenyl group, cycloalkenyl group, or aromatic group having not more than 20 carbons, more preferably an alkyl group, alkenyl group, or cycloalkenyl group having 1 to 6 carbons or an aromatic group having 6 to 10 carbons, yet more preferably an alkyl group having 1 to 6 carbons, and particularly preferably a methyl group or an ethyl group.

L is preferably a halogen atom or a hydrocarbyloxy group having not more than 20 carbons, more preferably a halogen atom or an alkoxy group having 1 to 6 carbons, and yet more preferably a chlorine atom, a methoxy group, or an ethoxy group.

When there are a plurality of R³s and Ls, the plurality of R³s and the plurality of Ls each may be identical to or different from each other, and are not particularly limited.

Examples of the coupling agent represented by Formula (IV) include silicon tetrachloride, methyltrichlorosilane, dimethyidichlorosilane, trimethylchlorosilane, tin tetrachloride, methyltrichlorotin, dimethyldichlorotin, trimethylchlorotin, tetramethoxysilane, methyltrimethoxysilane, dimethoxydimethylsilane, methyltriethoxysilane, ethyltrimethoxysilane, dimethoxydiethylsilane, diethoxydimethylsilane, tetraethoxysilane, ethyltriethoxysilane, and diethoxydiethylsilane.

From the viewpoint of processability of the conjugated diene polymer, the amount of coupling agent added is preferably not less than 0.03 mol per mol of alkali metal originating from an alkali metal catalyst, and more preferably not less than 0.05 mol. Furthermore, from the viewpoint of fuel economy, it is preferably not more than 0.4 mol, and more preferably not more than 0.3 mol.

The conjugated diene polymer may be recovered from the hydrocarbon solution of the conjugated diene polymer by a known recovery method such as, for example, (1) a method in which a coagulant is added to the hydrocarbon solution of the conjugated diene polymer or (2) a method in which steam is added to the hydrocarbon solution of the conjugated diene polymer. The conjugated diene polymer thus recovered may be dried by a known dryer such as a band dryer or an extrusion dryer.

Furthermore, in the process for producing a conjugated diene polymer of the present invention, a treatment in which a group, represented by Formula (II), of a polymer is replaced by a hydroxy group by hydrolysis, etc. may be carried out. This treatment may be carried out in a state in which the polymer is on its own or is in a compositional state, as described later.

The conjugated diene polymer of the present invention may be used in a conjugated diene polymer composition by combining another polymer component, an additive, etc. therewith.

Examples of said other polymer component include conventional styrene-butadiene copolymer rubber, polybutadiene rubber, butadiene-isoprene copolymer rubber, and butyl rubber. Examples further include natural rubber, an ethylene-propylene copolymer, and an ethylene-octene copolymer. These polymer components may be used in a combination of two or more types.

In the case where another polymer component is combined with the conjugated diene polymer of the present invention, from the viewpoint of fuel economy, the amount of conjugated diene polymer of the present invention combined, with the total amount of polymer components combined (including the amount of conjugated diene polymer combined) as 100 parts by weight, is preferably not less than 10 parts by weight, and more preferably not less than 20 parts by weight.

As the additive, a known additive may be used, and examples thereof include a vulcanizing agent such as sulfur; a vulcanization accelerator such as a thiazole-based vulcanization accelerator, a thiuram-based vulcanization accelerator, a sulfenamide-based vulcanization accelerator, or a guanidine-based vulcanization accelerator; a vulcanization activator such as stearic acid or zinc oxide; an organic peroxide; a filler such as silica, carbon black, calcium carbonate, talc, alumina, clay, aluminum hydroxide, or mica; a silane coupling agent; an extender oil; a processing aid; an antioxidant; and a lubricant.

Examples of the silica include dry silica (anhydrous silicic acid), wet silica (hydrated silicic acid), colloidal silica, precipitated silica, calcium silicate, and aluminum silicate. One type thereof may be used on its own, or two or more types thereof may be used in combination. The BET specific surface area of the silica is usually not less than 50 but not more than 250 m²/g. The BET specific surface area is measured in accordance with ASTM D1993-03. As a commercial product, trade names VN3, AQ, ER, and RS-150 manufactured by Tosoh Silica Corporation, trade names Zeosil 1115MP and 1165MP manufactured by Rhodia, etc. may be used.

Examples of the carbon black include furnace black, acetylene black, thermal black, channel black, and graphite. With regard to the carbon black, channel carbon black such as EPC, MPC, or CC; furnace carbon black such as SAF, ISAF, HAF, MAF, FEF, SRF, GPF, APF, FF, CF, SCF, or ECF; thermal carbon black such as FT or MT; and acetylene carbon black can be cited as examples. One type thereof may be used or two or more types thereof may be used in combination.

The nitrogen adsorption specific surface area (N₂SA) of the carbon black is usually not less than 5 but not more than 200 m²/g, and the dibutyl phthalate (DBP) absorption of carbon black is usually not less than 5 but not more than 300 mL/100 g. The nitrogen adsorption specific surface area is measured in accordance with ASTM D4820-93, and the DBP absorption is measured in accordance with ASTM D2414-93. As a commercial product, trade names SEAST 6, SEAST 7HM, and SEAST KH manufactured by Tokai Carbon Co., Ltd., trade names CK 3 and Special Black 4A manufactured by Degussa, Inc., etc. may be used.

Examples of the silane coupling agent include vinyltrichlorosilane, vinyltriethoxysilane, vinyltris(β-methoxyethoxy)silane, β-(3,4-epoxycyclohexyl)ethyltrimethoxysilane, γ-glycidoxypropyltrimethoxysilane, γ-methacryloxypropyltrimethoxysilane, N-(β-aminoethyl)-γ-aminopropyltrimethoxysilane, N-(β-aminoethyl)-γ-aminopropylmethyldimethoxysilane, N-phenyl-γ-aminopropyltrimethoxysilane, γ-chloropropyltrimethoxysilane, γ-mercaptopropyltrimethoxysilane, γ-aminopropyltriethoxysilane, bis(3-(triethoxysilyl)propyl)tetrasulfide, γ-trimethoxysilylpropyldimethylthiocarbamyl tetrasulfide, and γ-trimethoxysilylpropylbenzothiazyl tetrasulfide. One type thereof may be used or two or more types thereof may be used in combination. As a commercial product, trade names Si69 and Si75 manufactured by Degussa, Inc., etc. may be used.

Examples of the extender oil include an aromatic mineral oil (viscosity-gravity constant (V.G.C. value) not less than 0.900 but not more than 1.049), a naphthenic mineral oil (V.G.C. value not less than 0.850 but not more than 0.899), and a paraffinic mineral oil (V.G.C. value not less than 0.790 but not more than 0.849). The polycyclic aromatic content of the extender oil is preferably less than 3% by weight, and more preferably less than 1% by weight. The polycyclic aromatic content is measured in accordance with British Institute of Petroleum method 346/92. Furthermore, the aromatic compound content (CA) of the extender oil is preferably not less than 20% by weight. Two or more types of extender oils may be used in combination.

Examples of the vulcanization accelerator include thiazole-based vulcanization accelerators such as 2-mercaptobenzothiazole, dibenzothiazyl disulfide, and N-cyclohexyl-2-benzothiazylsulfenamide; thiuram-based crosslinking promoters such as tetramethylthiuram monosulfide and tetramethylthiuram disulfide; sulfenamide-based crosslinking promoters such as N-cyclohexyl-2-benzothiazolesulfenamide, N-t-butyl-2-benzothiazolesulfenamide, N-oxyethylene-2-benzothiazolesulfenamide, N-oxyethylene-2-benzothiazolesulfenamide, and N,N′-diisopropyl-2-benzothiazolesulfenamide; and guanidine-based vulcanization accelerators such as diphenylguanidine, diorthotolylguanidine and orthotolylbiguanidine. The amount thereof used is preferably not less than 0.1 but not more than 5 parts by weight relative to 100 parts by weight of rubber component, and more preferably not less than 0.2 but not more than 3 parts by weight.

When a conjugated diene polymer composition is formed by combining a filler with the conjugated diene polymer of the present invention, the amount of filler combined, relative to 100 parts by weight of the conjugated diene polymer of the present invention combined, is usually not less than 10 but not more than 150 parts by weight. From the viewpoint of fuel economy, the amount combined is preferably not less than 20 parts by weight, and more preferably not less than 30 parts by weight. From the viewpoint of reinforcement being enhanced, it is preferably not more than 120 parts by weight, and more preferably not more than 100 parts by weight.

When a conjugated diene polymer composition in which a filler is combined with the conjugated diene polymer of the present invention is used, from the viewpoint of fuel economy, it is preferable to use silica as a filler. The amount of silica combined is preferably not less than 50 parts by weight but not more than 100 parts by weight relative to 100 parts by weight of the total amount of fillers combined, and more preferably not less than 70 parts by weight but not more than 100 parts by weight.

As a method for producing a conjugated diene polymer composition by combining another polymer component, an additive, etc. with the conjugated diene polymer of the present invention, a known method such as, for example, a method in which each component is kneaded by means of a known mixer such as a roll or Banbury mixer can be used.

With regard to kneading conditions, when an additive other than a vulcanizing agent or a vulcanization accelerator is combined, the kneading temperature is usually not less than 50° C. but not more than 200° C. and preferably not less than 80° C. but not more than 190° C., and the kneading time is usually not less than 30 sec but not more than 30 min and preferably not less than 1 min but not more than 30 min. When a vulcanizing agent or a vulcanization accelerator is combined, the kneading temperature is usually not more than 100° C., and preferably not less than room temperature but not more than 80° C. A composition in which a vulcanizing agent or a vulcanization accelerator is combined is usually used by carrying out a vulcanization treatment such as press vulcanization. The vulcanization temperature is usually not less than 120° C. but not more than 200° C., and preferably not less than 140° C. but not more than 180° C.

The conjugated diene polymer and the conjugated diene polymer composition of the present invention have excellent fuel economy and processability, and good grip properties.

The conjugated diene polymer and the conjugated diene polymer composition of the present invention are used for tires, shoe soles, flooring materials, vibration-proofing materials, etc., and are particularly suitably used for tires.

In accordance with the present invention, it is possible to provide a conjugated diene polymer that can give a polymer composition having excellent fuel economy and processability when combined with silica as a filler, and a conjugated diene polymer composition formed by combining the conjugated diene polymer and a filler such as silica. The conjugated diene polymer composition has excellent fuel economy and processability and has good grip properties.

### EXAMPLES

The present invention is explained below by reference to Examples.

Physical properties were evaluated by the following methods.

### 1. Mooney Viscosity (ML₁₊₄)

The Mooney viscosity of a polymer was measured at 100° C. in accordance with JIS K6300 (1994).

### 2. Vinyl Content (Units: Mol %)

The vinyl content of a polymer was determined by IR spectroscopy from the absorption intensity at around 910 cm⁻¹, which is an absorption peak of a vinyl group.

### 3. Styrene Content (Units: % by Weight)

The styrene content of a polymer was determined from refractive index in accordance with JIS K6383 (1995).

### 4. Molecular Weight Distribution (Mw/Mn)

Weight-average molecular weight (Mw) and number-average molecular weight (Mn) were measured under conditions (1) to (8) below by a gel permeation chromatograph (GPC) method, and the molecular weight distribution (Mw/Mn) of a polymer was determined.
(1) Instrument: HLC-8020 manufactured by Tosoh Corporation
(2) Separation column: GMH-XL (2 columns in tandem) manufactured by Tosoh Corporation
(3) Measurement temperature: 40° C.
(4) Carrier: tetrahydrofuran
(5) Flow rate: 0.6 mL/min
(6) Amount injected: 5 μL
(7) Detector: differential refractometer
(8) Molecular weight standard: standard polystyrene

### 5. Fuel Economy

The loss tangent (tan δ (70° C.)) at 70° C. of a vulcanized sheet was measured using a viscoelastometer (manufactured by Ueshima Seisakusho) under conditions of a strain of 1% and a frequency of 10 Hz. The smaller this value, the better the fuel economy.

### 6. Grip Properties

The loss tangent (tan δ (0° C.)) at 0° C. of a vulcanized sheet was measured using a viscoelastometer (manufactured by Ueshima Seisakusho) under conditions of a strain of 0.25% and a frequency of 10 Hz. The larger this value, the better the grip properties.

### 7. Processability

100 parts by weight of polymer, 78.4 parts by weight of silica (trade name: Ultrasil VN3-G, manufactured by Degussa, Inc.), 6.4 parts by weight of a silane coupling agent (trade name: Si69, manufactured by Degussa, Inc.), 6.4 parts by weight of carbon, 47.6 parts by weight of an extender oil (trade name: X-140, manufactured by Kyodo Sekiyu), 1.5 parts by weight of an antioxidant (trade name: Antigene 3C, manufactured by Sumitomo Chemical Co., Ltd.), and 2 parts by weight of stearic acid were kneaded by means of a Labo Plastomill, and 2 parts by weight of zinc oxide and 1.5 parts by weight of a wax (trade name: Sunnoc N, manufactured by Ouchi Shinko Chemical Industrial Co., Ltd.) were kneaded to prepare a polymer composition. The polymer composition thus obtained was molded into a sheet using a two roll machine (roll gap 2.5 mm, roll diameter 6 inches). The appearance of the edge of the sheet thus obtained was examined and evaluated using the criteria below. The larger the number, the better the processability.
5: Very little unevenness, and there was a smooth portion of not less than 10 cm.
4: Little unevenness, and there was a smooth portion of not less than 7 cm.
3: Some unevenness, but there was a smooth portion of not less than 5 cm.
2: Much unevenness, but there was a smooth portion of not less than 3 cm.
1: Much unevenness, and no smooth portion could be observed.

### Example 1

A 5 L capacity stainless polymerization reactor was washed, dried, flushed with dry nitrogen, and charged with 2.55 kg of hexane (specific gravity 0.68 g/cm³), 137 g of 1,3-butadiene, 43 g of styrene, 1.5 mL of tetrahydrofuran, and 1.2 mL of ethylene glycol diethyl ether. Subsequently, 3.6 mmol of n-butyllithium was poured in as an n-hexane solution, and copolymerization of 1,3-butadiene and styrene was carried out for 0.42 hours. During polymerization, the stirring speed was 130 rpm, the polymerization reactor internal temperature was 65° C., and the monomers were supplied continuously to the polymerization reactor.

After the polymerization had been carried out for 0.42 hours, a solution of 2.8 mmol of Molecular Sieves (3A)-dried bis(diethylamino)methylvinylsilane dissolved in 10 mL of cyclohexane was quickly charged into the polymerization reactor under conditions of a stirring speed of 130 rpm and a polymerization reactor internal temperature of 65° C.

Subsequently, copolymerization of 1,3-butadiene and styrene was carried out for 2.08 hours by continuously supplying the monomers to the polymerization reactor. During polymerization, the stirring speed was 130 rpm, and the polymerization reactor internal temperature was 65° C.

After the polymerization had been carried out for 2.08 hours, 20 mL of a hexane solution containing 0.14 mL of methanol was charged into the polymerization reactor, and the polymer solution was stirred for 5 minutes.

The amount of 1,3-butadiene supplied during the entire polymerization was 342 g, and the amount of styrene supplied was 108 g.

To the polymer solution were added 1.8 g of 2-tert-butyl-6-(3-tert-butyl-2-hydroxy-5-methylbenzyl)-4-methylphenyl acrylate (trade name: Sumilizer GM, manufactured by Sumitomo Chemical Co., Ltd.), and 0.9 g of pentaerythrityl tetrakis(3-laurylthiopropionate) (trade name: Sumilizer TP-D, manufactured by Sumitomo Chemical Co., Ltd.). Subsequently, the polymer solution was evaporated at normal temperature for 24 hours, and further dried under vacuum at 55° C. for 12 hours, thus giving a polymer. The results of evaluation of the polymer are given in Table 1.

100 parts by weight of the polymer thus obtained, 78.4 parts by weight of silica (trade name: Ultrasil VN3-G, manufactured by Degussa, Inc.), 6.4 parts by weight of a silane coupling agent (trade name: Si69, manufactured by Degussa, Inc.), 6.4 parts by weight of carbon black, 47.6 parts by weight of an extender oil (trade name: X-140, manufactured by Kyodo Sekiyu), 1.5 parts by weight of an antioxidant (trade name: Antigene 3C, manufactured by Sumitomo Chemical Co., Ltd.), 2 parts by weight of stearic acid, 2 parts by weight of zinc oxide, 1 part by weight of a vulcanization accelerator (trade name: Soxinol CZ, manufactured by Sumitomo Chemical Co., Ltd.), 1 part by weight of a vulcanization accelerator (trade name: Soxinol D, manufactured by Sumitomo Chemical Co., Ltd.), 1.5 parts by weight of a wax (trade name: Sunnoc N, manufactured by Ouchi Shinko Chemical Industrial Co., Ltd.), and 1.4 parts by weight of sulfur were kneaded by means of a Labo Plastomill to prepare a polymer composition. The polymer composition thus obtained was molded into a sheet using a 6 inch roll, and the sheet was vulcanized by heating at 160° C. for 45 minutes, thus giving a vulcanized sheet. The results of evaluation of the physical properties of the vulcanized sheet are given in Table 1.

### Example 2

A 5 L capacity stainless polymerization reactor was washed, dried, flushed with dry nitrogen, and charged with 2.55 kg of hexane (specific gravity 0.68 g/cm³), 137 g of 1,3-butadiene, 43 g of styrene, 1.5 mL of tetrahydrofuran, and 1.2 mL of ethylene glycol diethyl ether. Subsequently, 3.6 mmol of n-butyllithium was poured in as an n-hexane solution, and copolymerization of 1,3-butadiene and styrene was carried out for 0.67 hours. During polymerization, the stirring speed was 130 rpm, the polymerization reactor internal temperature was 65° C., and the monomers were supplied continuously to the polymerization reactor.

After the polymerization had been carried out for 0.67 hours, a solution of 2.8 mmol of Molecular Sieves (3A)-dried bis(diethylamino)methylvinylsilane dissolved in 10 mL of cyclohexane was quickly charged into the polymerization reactor under conditions of a stirring speed of 130 rpm and a polymerization reactor internal temperature of 65° C.

Subsequently, copolymerization of 1,3-butadiene and styrene was carried out for 0.58 hours by continuously supplying the monomers to the polymerization reactor. During polymerization, the stirring speed was 130 rpm, and the polymerization reactor internal temperature was 65° C.

After the polymerization had been carried out for 0.58 hours, a solution of 2.8 mmol of Molecular Sieves (3A)-dried bis(diethylamino)methylvinylsilane dissolved in 10 mL of cyclohexane was quickly charged into the polymerization reactor under conditions of a stirring speed of 130 rpm and a polymerization reactor internal temperature of 65° C.

Subsequently, copolymerization of 1,3-butadiene and styrene was carried out for 1.25 hours by continuously supplying the monomers to the polymerization reactor. During polymerization, the stirring speed was 130 rpm, and the polymerization reactor internal temperature was 65° C.

After the polymerization had been carried out for 1.25 hours, 10 mL of a hexane solution containing 0.1 mL of methanol was charged into the polymerization reactor, and the polymer solution was stirred for 5 minutes.

The amount of 1,3-butadiene supplied during the entire polymerization was 205 g, and the amount of styrene supplied was 65 g.

To the polymer solution were added 1.8 g of 2-tert-butyl-6-(3-tert-butyl-2-hydroxy-5-methylbenzyl)-4-methylphenyl acrylate (trade name: Sumilizer GM, manufactured by Sumitomo Chemical Co., Ltd.), and 0.9 g of pentaerythrityl tetrakis(3-laurylthiopropionate) (trade name: Sumilizer TP-D, manufactured by Sumitomo Chemical Co., Ltd.). Subsequently, the polymer solution was evaporated at normal temperature for 24 hours, and further dried under vacuum at 55° C. for 12 hours, thus giving a polymer. The results of evaluation of the polymer are given in Table 1.

100 parts by weight of the polymer thus obtained, 78.4 parts by weight of silica (trade name: Ultrasil VN3-G, manufactured by Degussa, Inc.), 6.4 parts by weight of a silane coupling agent (trade name: Si69, manufactured by Degussa, Inc.), 6.4 parts by weight of carbon black, 47.6 parts by weight of an extender oil (trade name: X-140, manufactured by Kyodo Sekiyu), 1.5 parts by weight of an antioxidant (trade name: Antigene 3C, manufactured by Sumitomo Chemical Co., Ltd.), 2 parts by weight of stearic acid, 2 parts by weight of zinc oxide, 1 part by weight of a vulcanization accelerator (trade name: Soxinol CZ, manufactured by Sumitomo Chemical Co., Ltd.), 1 part by weight of a vulcanization accelerator (trade name: Soxinol D, manufactured by Sumitomo Chemical Co., Ltd.), 1.5 parts by weight of a wax (trade name: Sunnoc N, manufactured by Ouchi Shinko Chemical Industrial Co., Ltd.), and 1.4 parts by weight of sulfur were kneaded by means of a Labo Plastomill to prepare a polymer composition. The polymer composition thus obtained was molded into a sheet using a 6 inch roll, and the sheet was vulcanized by heating at 160° C. for 45 minutes, thus giving a vulcanized sheet. The results of evaluation of the physical properties of the vulcanized sheet are given in Table 1.

### Example 3

A 5 L capacity stainless polymerization reactor was washed, dried, flushed with dry nitrogen, and charged with 2.55 kg of hexane (specific gravity 0.68 g/cm³), 137 g of 1,3-butadiene, 43 g of styrene, 1.5 mL of tetrahydrofuran, and 1.2 mL of ethylene glycol diethyl ether. Subsequently, 3.6 mmol of n-butyllithium was poured in as an n-hexane solution, and copolymerization of 1,3-butadiene and styrene was carried out for 0.45 hours. During polymerization, the stirring speed was 130 rpm, the polymerization reactor internal temperature was 65° C., and the monomers were supplied continuously to the polymerization reactor.

After the polymerization had been carried out for 0.45 hours, a solution of 2.8 mmol of Molecular Sieves (3A)-dried bis(diethylamino)methylvinylsilane dissolved in 10 mL of cyclohexane was quickly charged into the polymerization reactor under conditions of a stirring speed of 130 rpm and a polymerization reactor internal temperature of 65° C.

Subsequently, copolymerization of 1,3-butadiene and styrene was carried out for 2.05 hours by continuously supplying the monomers to the polymerization reactor. During polymerization, the stirring speed was 130 rpm, and the polymerization reactor internal temperature was 65° C.

After the polymerization had been carried out for 2.05 hours, a solution of 2.8 mmol of Molecular Sieves (3A)-dried bis(diethylamino)methylvinylsilane dissolved in 10 mL of cyclohexane was quickly charged into the polymerization reactor under conditions of a stirring speed of 130 rpm and a polymerization reactor internal temperature of 65° C., and stirred for 0.5 hours.

Subsequently, 10 mL of a hexane solution containing 0.1 mL of methanol was charged into the polymerization reactor, and the polymer solution was stirred for 5 minutes.

The amount of 1,3-butadiene supplied during the entire polymerization was 205 g, and the amount of styrene supplied was 65 g.

To the polymer solution were added 1.8 g of 2-tert-butyl-6-(3-tert-butyl-2-hydroxy-5-methylbenzyl)-4-methylphenyl acrylate (trade name: Sumilizer GM, manufactured by Sumitomo Chemical Co., Ltd.), and 0.9 g of pentaerythrityl tetrakis(3-laurylthiopropionate) (trade name: Sumilizer TP-D, manufactured by Sumitomo Chemical Co., Ltd.). Subsequently, the polymer solution was evaporated at normal temperature for 24 hours, and further dried under vacuum at 55° C. for 12 hours, thus giving a polymer. The results of evaluation of the polymer are given in Table 1.

100 parts by weight of the polymer thus obtained, 78.4 parts by weight of silica (trade name: Ultrasil VN3-G, manufactured by Degussa, Inc.), 6.4 parts by weight of a silane coupling agent (trade name: Si69, manufactured by Degussa, Inc.), 6.4 parts by weight of carbon black, 47.6 parts by weight of an extender oil (trade name: X-140, manufactured by Kyodo Sekiyu), 1.5 parts by weight of an antioxidant (trade name: Antigene 3C, manufactured by Sumitomo Chemical Co., Ltd.), 2 parts by weight of stearic acid, 2 parts by weight of zinc oxide, 1 part by weight of a vulcanization accelerator (trade name: Soxinol CZ, manufactured by Sumitomo Chemical Co., Ltd.), 1 part by weight of a vulcanization accelerator (trade name: Soxinol D, manufactured by Sumitomo Chemical Co., Ltd.), 1.5 parts by weight of a wax (trade name: Sunnoc N, manufactured by Ouchi Shinko Chemical Industrial Co., Ltd.), and 1.4 parts by weight of sulfur were kneaded by means of a Labo Plastomill to prepare a polymer composition. The polymer composition thus obtained was molded into a sheet using a 6 inch roll, and the sheet was vulcanized by heating at 160° C. for 45 minutes, thus giving a vulcanized sheet. The results of evaluation of the physical properties of the vulcanized sheet are given in Table 1.

### Comparative Example 1

A 5 L capacity stainless polymerization reactor was washed, dried, flushed with dry nitrogen, and charged with 2.55 kg of hexane (specific gravity 0.68 g/cm³), 137 g of 1,3-butadiene, 43 g of styrene, 1.5 mL of tetrahydrofuran, and 1.2 mL of ethylene glycol diethyl ether. Subsequently, 3.6 mmol of n-butyllithium was poured in as an n-hexane solution, and copolymerization of 1,3-butadiene and styrene was carried out for 2.5 hours. During polymerization, the stirring speed was 130 rpm, the polymerization reactor internal temperature was 65° C., and the monomers were supplied continuously to the polymerization reactor. The amount of 1,3-butadiene supplied was 342 g, and the amount of styrene supplied was 108 g.

After the polymerization had been carried out for 2.5 hours, a solution of 2.8 mmol of Molecular Sieves (3A)-dried bis(diethylamino)methylvinylsilane dissolved in 10 mL of cyclohexane was quickly charged into the polymerization reactor under conditions of a stirring speed of 130 rpm and a polymerization reactor internal temperature of 65° C., and stirred for 30 minutes.

Subsequently, 20 mL of a hexane solution containing 0.14 mL of methanol was charged into the polymerization reactor, and the polymer solution was stirred for 5 minutes.

To the polymer solution were added 1.8 g of 2-tert-butyl-6-(3-tert-butyl-2-hydroxy-5-methylbenzyl)-4-methylphenyl acrylate (trade name: Sumilizer GM, manufactured by Sumitomo Chemical Co., Ltd.), and 0.9 g of pentaerythrityl tetrakis(3-laurylthiopropionate) (trade name: Sumilizer TP-D, manufactured by Sumitomo Chemical Co., Ltd.). Subsequently, the polymer solution was evaporated at normal temperature for 24 hours, and further dried under vacuum at 55° C. for 12 hours, thus giving a polymer. The results of evaluation of the polymer are given in Table 1.

100 parts by weight of the polymer thus obtained, 78.4 parts by weight of silica (trade name: Ultrasil VN3-G, manufactured by Degussa, Inc.), 6.4 parts by weight of a silane coupling agent (trade name: Si69, manufactured by Degussa, Inc.), 6.4 parts by weight of carbon black, 47.6 parts by weight of an extender oil (trade name: X-140, manufactured by Kyodo Sekiyu), 1.5 parts by weight of an antioxidant (trade name: Antigene 3C, manufactured by Sumitomo Chemical Co., Ltd.), 2 parts by weight of stearic acid, 2 parts by weight of zinc oxide, 1 part by weight of a vulcanization accelerator (trade name: Soxinol CZ, manufactured by Sumitomo Chemical Co., Ltd.), 1 part by weight of a vulcanization accelerator (trade name: Soxinol D, manufactured by Sumitomo Chemical Co., Ltd.), 1.5 parts by weight of a wax (trade name: Sunnoc N, manufactured by Ouchi Shinko Chemical Industrial Co., Ltd.), and 1.4 parts by weight of sulfur were kneaded by means of a Labo Plastomill to prepare a polymer composition. The polymer composition thus obtained was molded into a sheet using a 6 inch roll, and the sheet was vulcanized by heating at 160° C. for 45 minutes, thus giving a vulcanized sheet. The results of evaluation of the physical properties of the vulcanized sheet are given in Table 1.

### Comparative Example 2

A 20 L capacity stainless polymerization reactor was washed, dried, flushed with dry nitrogen, and charged with 10.2 kg of hexane (specific gravity 0.68 g/cm³), 547 g of 1,3-butadiene, 173 g of styrene, 6.1 mL of tetrahydrofuran, and 5.0 mL of ethylene glycol diethyl ether. Subsequently, 13.6 mmol of n-butyllithium was poured in as an n-hexane solution, and copolymerization of 1,3-butadiene and styrene was carried out for 1 hour. During polymerization, the stirring speed was 130 rpm, the polymerization reactor internal temperature was 65° C., and the monomers were supplied continuously to the polymerization reactor.

After the polymerization had been carried out for 1 hour, a solution of 11.0 mmol of Molecular Sieves (3A)-dried bis(diethylamino)methylvinylsilane dissolved in 13.3 mL of cyclohexane was quickly charged into the polymerization reactor under conditions of a stirring speed of 130 rpm and a polymerization reactor internal temperature of 65° C.

Subsequently, copolymerization of 1,3-butadiene and styrene was carried out for 0.5 hours by continuously supplying the monomers to the polymerization reactor. During polymerization, the stirring speed was 130 rpm, and the polymerization temperature was 65° C.

After the polymerization had been carried out for 0.5 hours, a solution of 11.0 mmol of Molecular Sieves (3A)-dried bis(diethylamino)methylvinylsilane dissolved in 13.3 mL of cyclohexane was quickly charged into the polymerization reactor under conditions of a stirring speed of 130 rpm and a polymerization reactor internal temperature of 65° C.

Subsequently, copolymerization of 1,3-butadiene and styrene was carried out for 0.5 hours by continuously supplying the monomers to the polymerization reactor. During polymerization, the stirring speed was 130 rpm, and the polymerization temperature was 65° C.

After the polymerization had been carried out for 0.5 hours, a solution of 11.0 mmol of Molecular Sieves (3A)-dried bis(diethylamino)methylvinylsilane dissolved in 13.3 mL of cyclohexane was quickly charged into the polymerization reactor under conditions of a stirring speed of 130 rpm and a polymerization reactor internal temperature of 65° C.

Subsequently, copolymerization of 1,3-butadiene and styrene was carried out for 1 hour by continuously supplying the monomers to the polymerization reactor. During polymerization, the stirring speed was 130 rpm, and the polymerization temperature was 65° C.

After the polymerization had been carried out for 1 hour, 20 mL of a hexane solution containing 0.5 mL of methanol was charged into the polymerization reactor, and the polymer solution was stirred for 5 minutes.

The amount of 1,3-butadiene supplied during the entire polymerization was 821 g, and the amount of styrene supplied was 259 g.

To the polymer solution were added 1.8 g of 2-tert-butyl-6-(3-tert-butyl-2-hydroxy-5-methylbenzyl)-4-methylphenyl acrylate (trade name: Sumilizer GM, manufactured by Sumitomo Chemical Co., Ltd.), and 0.9 g of pentaerythrityl tetrakis(3-laurylthiopropionate) (trade name: Sumilizer TP-D, manufactured by Sumitomo Chemical Co., Ltd.). Subsequently, the polymer solution was evaporated at normal temperature for 24 hours, and further dried under vacuum at 55° C. for 12 hours, thus giving a polymer. The results of evaluation of the polymer are given in Table 1.

100 parts by weight of the polymer thus obtained, 78.4 parts by weight of silica (trade name: Ultrasil VN3-G, manufactured by Degussa, Inc.), 6.4 parts by weight of a silane coupling agent (trade name: Si69, manufactured by Degussa, Inc.), 6.4 parts by weight of carbon black, 47.6 parts by weight of an extender oil (trade name: X-140, manufactured by Kyodo Sekiyu), 1.5 parts by weight of an antioxidant (trade name: Antigene 3C, manufactured by Sumitomo Chemical Co., Ltd.), 2 parts by weight of stearic acid, 2 parts by weight of zinc oxide, 1 part by weight of a vulcanization accelerator (trade name: Soxinol CZ, manufactured by Sumitomo Chemical Co., Ltd.), 1 part by weight of a vulcanization accelerator (trade name: Soxinol D, manufactured by Sumitomo Chemical Co., Ltd.), 1.5 parts by weight of a wax (trade name: Sunnoc N, manufactured by Ouchi Shinko Chemical Industrial Co., Ltd.), and 1.4 parts by weight of sulfur were kneaded by means of a Labo Plastomill to prepare a polymer composition. The polymer composition thus obtained was molded into a sheet using a 6 inch roll, and the sheet was vulcanized by heating at 160° C. for 45 minutes, thus giving a vulcanized sheet. The results of evaluation of the physical properties of the vulcanized sheet are given in Table 1.

### Example 4

A 20 L capacity stainless polymerization reactor was washed, dried, flushed with dry nitrogen, and charged with 10.2 kg of hexane (specific gravity 0.68 g/cm³), 547 g of 1,3-butadiene, 173 g of styrene, 6.1 mL of tetrahydrofuran, and 5.0 mL of ethylene glycol diethyl ether. Subsequently, 13.4 mmol of n-butyllithium was poured in as an n-hexane solution, and copolymerization of 1,3-butadiene and styrene was carried out for 1.5 hours. During polymerization, the stirring speed was 130 rpm, the polymerization reactor internal temperature was 65° C., and the monomers were supplied continuously to the polymerization reactor.

After the polymerization had been carried out for 1.5 hours, a solution of 11.0 mmol of Molecular Sieves (3A)-dried bis(dimethylamino)methylvinylsilane dissolved in 10 mL of cyclohexane was quickly charged into the polymerization reactor under conditions of a stirring speed of 130 rpm and a polymerization reactor internal temperature of 65° C.

Subsequently, copolymerization of 1,3-butadiene and styrene was carried out for 1.5 hours by continuously supplying the monomers to the polymerization reactor. During polymerization, the stirring speed was 130 rpm, and the polymerization temperature was 65° C.

After the polymerization had been carried out for 1.5 hours, a solution of 11.0 mmol of Molecular Sieves (3A)-dried bis(dimethylamino)methylvinylsilane dissolved in 10 mL of cyclohexane was quickly charged into the polymerization reactor under conditions of a stirring speed of 130 rpm and a polymerization reactor internal temperature of 65° C., and stirred for 1 hour.

Subsequently, 20 mL of a hexane solution containing 0.5 mL of methanol was charged into the polymerization reactor, and the polymer solution was stirred for 5 minutes.

The amount of 1,3-butadiene supplied during the entire polymerization was 821 g, and the amount of styrene supplied was 259 g.

To the polymer solution were added 1.8 g of 2-tert-butyl-6-(3-tert-butyl-2-hydroxy-5-methylbenzyl)-4-methylphenyl acrylate (trade name: Sumilizer GM, manufactured by Sumitomo Chemical Co., Ltd.), and 0.9 g of pentaerythrityl tetrakis(3-laurylthiopropionate) (trade name: Sumilizer TP-D, manufactured by Sumitomo Chemical Co., Ltd.). Subsequently, the polymer solution was evaporated at normal temperature for 24 hours, and further dried under vacuum at 55° C. for 12 hours, thus giving a polymer. The results of evaluation of the polymer are given in Table 1.

100 parts by weight of the polymer thus obtained, 78.4 parts by weight of silica (trade name: Ultrasil VN3-G, manufactured by Degussa, Inc.), 6.4 parts by weight of a silane coupling agent (trade name: Si69, manufactured by Degussa, Inc.), 6.4 parts by weight of carbon black, 47.6 parts by weight of an extender oil (trade name: X-140, manufactured by Kyodo Sekiyu), 1.5 parts by weight of an antioxidant (trade name: Antigene 3C, manufactured by Sumitomo Chemical Co., Ltd.), 2 parts by weight of stearic acid, 2 parts by weight of zinc oxide, 1 part by weight of a vulcanization accelerator (trade name: Soxinol CZ, manufactured by Sumitomo Chemical Co., Ltd.), 1 part by weight of a vulcanization accelerator (trade name: Soxinol D, manufactured by Sumitomo Chemical Co., Ltd.), 1.5 parts by weight of a wax (trade name: Sunnoc N, manufactured by Ouchi Shinko Chemical Industrial Co., Ltd.), and 1.4 parts by weight of sulfur were kneaded by means of a Labo Plastomill to prepare a polymer composition. The polymer composition thus obtained was molded into a sheet using a 6 inch roll, and the sheet was vulcanized by heating at 160° C. for 45 minutes, thus giving a vulcanized sheet. The results of evaluation of the physical properties of the vulcanized sheet are given in Table 1.

TABLE 1

| | | | | | Comp. | Comp. | |
|---|---|---|---|---|---|---|---|
| | | Ex. 1 | Ex. 2 | Ex. 3 | Ex. 1 | Ex. 2 | Ex. 4 |
| Mooney Viscosity | — | 44 | 36 | 41 | 38 | 40 | 51 |
| Vinyl content | % | 60 | 59 | 59 | 59 | 59 | 59 |
| Styrene content | % by weight | 24 | 24 | 24 | 25 | 25 | 25 |
| Molecular weight | — | 1.10 | 1.08 | 1.18 | 1.14 | 1.10 | 1.36 |
| distribution | | | | | | | |
| Fuel economy | — | 0.145 | 0.124 | 0.115 | 0.197 | 0.113 | 0.117 |
| tanδ (70° C.) | | | | | | | |
| Grip properties | — | 0.929 | 1.061 | 1.102 | 0.679 | 1.114 | 0.725 |
| tanδ (0° C.) | | | | | | | |
| Processability | — | 4 | 4 | 4 | 4 | 2 | 3 |

1. A conjugated diene polymer comprising:
a conjugated diene-based constituent unit and a constituent unit represented by Formula (I) below;
the constituent unit represented by Formula (I) being present between a conjugated diene-based constituent unit and a conjugated diene-based constituent unit; and
the content of the constituent unit represented by Formula (I) being 1 unit or 2 units per polymer chain, 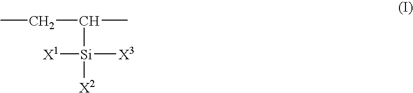
wherein X¹, X², and X³ independently denote a group represented by Formula (II) below, a hydroxy group, a hydrocarbyl group, or a substituted hydrocarbyl group, and at least one of X¹, X², and X³ is a group represented by Formula (II) below or a hydroxy group, 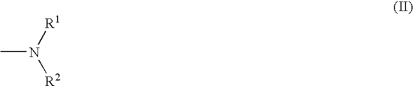
wherein R¹ and R² independently denote a hydrocarbyl group having 1 to 6 carbons, a substituted hydrocarbyl group having 1 to 6 carbons, a silyl group, or a substituted silyl group, and R¹ and R² may be bonded so as to form, together with the N atom, a ring structure.

2. The conjugated diene polymer according to claim 1, wherein R¹ and R² of Formula (II) are independently a methyl group, an ethyl group, an n-propyl group, or an n-butyl group.

3. The conjugated diene polymer according to claim 1, wherein two of X¹, X², and X³ of Formula (I) are a group represented by Formula (II) or a hydroxy group.

4. The conjugated diene polymer according to claim 1, wherein, with the content of the conjugated diene-based constituent unit as 100 mol %, the conjugated diene polymer has a vinyl bond content of not less than 10 mol % but not more than 80 mol %.

5. The conjugated diene polymer according to claim 1, wherein it comprises, in addition to the conjugated diene-based constituent unit and the constituent unit represented by Formula (I), an aromatic vinyl-based constituent unit.

6. The conjugated diene polymer according to claim 5, wherein, with the total amount of the conjugated diene-based constituent unit and the aromatic vinyl-based constituent unit as 100% by weight, the content of the aromatic vinyl-based constituent unit is not less than 10% by weight but not more than 50% by weight.

7. The conjugated diene polymer according to claim 1, wherein the conjugated diene polymer has a Mooney viscosity (ML₁₊₄) of not less than 10 but not more than 200.

8. The conjugated diene polymer according to claim 1, wherein the conjugated diene polymer has a molecular weight distribution of not less than 1 but not more than 2.

9. The conjugated diene polymer according to claim 1, wherein the constituent unit represented by Formula (I) is a bis(dialkylamino)alkylvinylsilane-based constituent unit.

10. A conjugated diene polymer composition formed by combining the conjugated diene polymer according to claim 1 and a filler.

11. The conjugated diene polymer composition according to claim 10, wherein the amount of filler combined is not less than 10 but not more than 150 parts by weight relative to 100 parts by weight of the amount of conjugated diene polymer combined.

12. The conjugated diene polymer composition according to claim 10, wherein the filler comprises silica.

13. The conjugated diene polymer composition according to claim 12, wherein the amount of silica combined is not less than 50 parts by weight relative to 100 parts by weight of the total amount of filler combined.

14. The conjugated diene polymer composition according to claim 10, wherein it further comprises a vulcanizing agent and/or a vulcanization accelerator.

15. A vulcanizate formed by vulcanizing the conjugated diene polymer composition according to claim 14.

16. A process for producing the conjugated diene polymer according to claim 1, the process comprising steps A, B, and C below
(Step A) a step of polymerizing a monomer comprising a conjugated diene in a hydrocarbon solvent by an alkali metal catalyst, thus giving a conjugated diene polymer having at a polymer chain terminal an alkali metal originating from the alkali metal catalyst,
(Step B) a step of adding a silicon compound represented by Formula (III) below to a hydrocarbon solution of a conjugated diene polymer having at a polymer chain terminal an alkali metal originating from an alkali metal catalyst and reacting the silicon compound with the polymer chain terminal, thus giving a conjugated diene polymer having at a polymer chain terminal a structure in which an alkali metal originating from an alkali metal catalyst is bonded to a constituent unit based on the silicon compound represented by Formula (III), and
(Step C) a step of adding a monomer comprising a conjugated diene to a hydrocarbon solution of a conjugated diene polymer having at a polymer chain terminal a structure in which an alkali metal originating from an alkali metal catalyst is bonded to a constituent unit represented by Formula (I) below, thus polymerizing the monomer at the polymer chain terminal 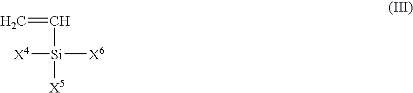
wherein X⁴, X⁵, and X⁶ independently denote a group represented by Formula (II) below, a hydrocarbyl group, or a substituted hydrocarbyl group, and at least one of X⁴, X⁵, and X⁶ is a group represented by Formula (II) below, 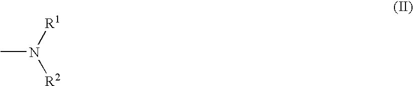
wherein R¹ and R² independently denote a hydrocarbyl group having 1 to 6 carbons, a substituted hydrocarbyl group having 1 to 6 carbons, a silyl group, or a substituted silyl group, and R¹ and R² may be bonded so as to form, together with the N atom, a ring structure, 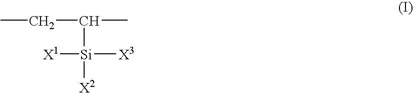
wherein X¹, X², and X³ independently denote a group represented by Formula (II) below, a hydroxy group, a hydrocarbyl group, or a substituted hydrocarbyl group, and at least one of X¹, X², and X³ is a group represented by Formula (II) below or a hydroxy group, 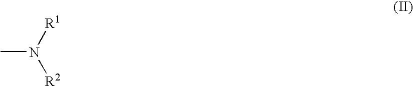
wherein R¹ and R² independently denote a hydrocarbyl group having 1 to 6 carbons, a substituted hydrocarbyl group having 1 to 6 carbons, a silyl group, or a substituted silyl group, and R¹ and R² may be bonded so as to form, together with the N atom, a ring structure.
